(19) United States
(12) Patent Application Publication
(10) Pub. No.: US 2014/0337225 A1
(43) Pub. Date: Nov. 13, 2014

(54) BIOMETRIC-BASED TRANSACTION FRAUD DETECTION

(71) Applicant: The Toronto-Dominion Bank, Mississauga (CA)

(72) Inventors: Lauren VAN HEERDEN, Bedford, NH (US); Prabaharan Sivashanmugam, Farmington Hills, MI (US); Michael D. Cummins, Pickering (CA); Orin Del Vecchio, Richmond Hill (CA); Gunalan Nadarajah, Milton (CA); Nino Di Teodoro, St. Catherine's (CA)

(73) Assignee: The Toronto-Dominion Bank, Mississauga (CA)

(21) Appl. No.: 14/273,469

(22) Filed: May 8, 2014

Related U.S. Application Data
(60) Provisional application No. 61/820,978, filed on May 8, 2013.

(51) Int. Cl. G06Q 20/40

(52) U.S. Cl. CPC G06Q 20/4016; G06Q 20/40145
USPC 705/44

(57) ABSTRACT

A method of identifying potentially fraudulent electronic transactions at an electronic transaction device may involve the transaction device receiving a transaction request for an electronic transaction. The transaction request may include a biometric credential sample and an authentication credential. Upon locating in the transaction history (i) no entry corresponding to the biometric credential sample or (ii) an entry comprising the biometric credential sample in association with the authentication credential, the electronic transaction device may insert into the transaction history a new entry comprising the biometric credential sample in association with the authentication credential and initiates completion of the electronic transaction. Otherwise, the transaction device may insert into the transaction history a new entry comprising the biometric credential sample in association with the authentication credential and generates an alarm signal identifying the electronic transaction as potentially fraudulent.

### CROSS-REFERENCE TO RELATED APPLICATION

This application claims the benefit of priority to U.S. Provisional Application No. 61/820,978, filed on May 8, 2013, the disclosure of which is incorporated herein by reference to its entirety.

### BACKGROUND

1. Technical Field

This patent application relates to methods and devices for detecting fraudulent electronic transactions.

2. Background Information

The fraudulent use of stolen payment or credit cards to make illegal withdrawals from automated banking machines (ABMs) and automated teller machines (ATMs) is an ongoing concern to financial institutions. Biometrics have been proposed as a means to curtail these fraudulent activities. For example, some techniques compare a fingerprint biometric received at an ATM with a reference biometric stored on the payment card to determine whether the user attending at the ATM is the authorized user of the payment card. Although this approach may offer improved fraud prevention over conventional personal identification number (PIN)-based authentication, ease of deployment may be limited by the need to store reference biometrics on payment cards and to modify the ATM hardware to accept the fingerprint biometrics. Further, the identification of suspicious persons is limited by the need to obtain reference facial biometric information and to ensure that the reference facial biometric information is correctly associated with the registered users.

### SUMMARY

The disclosed embodiments include an electronic transaction device and computerized method that identifies potentially fraudulent electronic transactions that are initiated at the electronic transaction device.

In some embodiments, a computerized method identifies potentially fraudulent electronic transactions at an electronic transaction device. The electronic transaction device may include a biometric credential reader and may maintain at the electronic transaction device a transaction history of electronic transactions initiated at the electronic transaction device. The method may, for example, involve the electronic transaction device receiving a transaction request for an electronic transaction with the electronic transaction device. The electronic transaction request may include an authentication credential, and may further include a biometric credential sample read from the biometric credential reader.

Upon the electronic transaction device locating in the transaction history (i) no entry corresponding to the biometric credential sample or (ii) an entry including the biometric credential sample in association with the authentication credential, the electronic transaction device may insert into the transaction history a new entry including the biometric credential sample in association with the authentication credential and may initiate completion of the electronic transaction by transmitting particulars of the transaction request over a payment network. Otherwise, the electronic transaction device may insert into the transaction history the new entry including the biometric credential sample in association with the authentication credential and generates an alarm signal identifying the electronic transaction as potentially fraudulent.

In some embodiments, there is provided an electronic transaction device that includes a biometric credential reader, a transaction history of electronic transactions initiated at the electronic transaction device, and a transaction processing system that is coupled to the biometric credential reader and the transaction history. The transaction history may be local to the electronic transaction device. The transaction processing system may be configured to receive a transaction request for an electronic transaction with the electronic transaction device. The electronic transaction request may include an authentication credential and further, may include a biometric credential sample read from the biometric credential reader.

The transaction processing system may be configured to insert into the transaction history a new entry that includes the biometric credential sample in association with the authentication credential and initiate completion of the electronic transaction by transmitting particulars of the transaction request over a payment network, upon locating in the transaction history (i) no prior entry corresponding to the biometric credential sample or (ii) a prior entry including the biometric credential sample in association with the authentication credential. Otherwise, the transaction processing system may insert into the transaction history the new entry including the biometric credential sample in association with the authentication credential and may generate an alarm signal identifying the electronic transaction as potentially fraudulent.

In some aspects, the electronic transaction device may delete the new entry from the transaction history a predetermined time after inserting the new entry into the transaction history. In other aspects, the electronic transaction device may purge the transaction history prior to inserting the new entry into the transaction history.

Since the electronic transaction device inserts into the transaction history the new entry including the biometric credential sample when the transaction history includes no entry corresponding to the biometric credential sample, users of the electronic transaction device need not pre-register their respective biometric credential samples with the electronic transaction device.

The disclosed embodiments include, for example, a method of identifying potentially fraudulent electronic transactions at an electronic transaction device. In some aspects, the electronic transaction device may include a biometric credential reader and may maintain at the electronic transaction device a transaction history of electronic transactions initiated at the electronic transaction device. The method may include receiving, by the electronic transaction device, a transaction request for an electronic transaction with the electronic transaction device. In some aspects, the electronic transaction request may include an authentication credential and may further include a biometric credential sample read from the biometric credential reader. Upon locating in the transaction history (i) no entry corresponding to the biometric credential sample or (ii) an entry including the biometric credential sample in association with the authentication credential, the method may include inserting, by the electronic transaction device, and into the transaction history a new entry including the biometric credential sample in association with the authentication credential and initiating completion of the electronic transaction by transmitting particulars of the transaction request over a payment network. Otherwise, the method may include inserting, by the electronic transaction device, and into the transaction history, the new entry including the biometric credential sample in association with the authentication credential and generating, by the electronic transaction device, an alarm signal identifying the electronic transaction as potentially fraudulent.

The disclosed embodiments also include electronic transaction device having a biometric credential reader, a storage device storing a transaction history of electronic transactions initiated at the electronic transaction device, the transaction history being local to the electronic transaction device, and at least one processor coupled to the storage device and the biometric credential reader. The storage device may further store software instructions for controlling the at least one processor when executed by the at least one processor. In an embodiment, the at least one processor is operative with the software instructions and configured to receive a transaction request for an electronic transaction with the electronic transaction device. In some aspects, the electronic transaction request may include an authentication credential and may further include a biometric credential sample read from the biometric credential reader. Upon locating in the transaction history (i) no entry corresponding to the biometric credential sample or (ii) an entry including the biometric credential sample in association with the authentication credential, the at least one processor may be further configured to insert into the transaction history a new entry including the biometric credential sample in association with the authentication credential and initiate completion of the electronic transaction by transmitting particulars of the transaction request over a payment network. Otherwise, the at least one processor may be configured to insert into the transaction history the new entry including the biometric credential sample in association with the authentication credential and generate an alarm signal identifying the electronic transaction as potentially fraudulent.

Other disclosed embodiments include a tangible, non-transitory computer-readable medium storing instructions which, when executed by at least one processor, cause the at least one processor to perform a method of identifying potentially fraudulent electronic transactions at an electronic transaction device. In some aspects, the electronic transaction device may include a biometric credential reader and may maintain at the electronic transaction device a transaction history of electronic transactions initiated at the electronic transaction device. The method may include receiving a transaction request for an electronic transaction with the electronic transaction device. In some aspects, the electronic transaction request may include an authentication credential and may further include a biometric credential sample read from the biometric credential reader. Upon locating in the transaction history (i) no entry corresponding to the biometric credential sample or (ii) an entry including the biometric credential sample in association with the authentication credential, the method may include inserting into the transaction history a new entry including the biometric credential sample in association with the authentication credential and initiating completion of the electronic transaction by transmitting particulars of the transaction request over a payment network. Otherwise, the method may include inserting the new entry into the transaction history, the new entry including the biometric credential sample in association with the authentication credential and generating an alarm signal identifying the electronic transaction as potentially fraudulent.

It is to be understood that both the foregoing general description and the following detailed description are exemplary and explanatory only, and are not restrictive of the disclosed embodiments as claimed. Further, the accompanying drawings, which are incorporated in and constitute a part of this specification, illustrate aspects of the present disclosure and together with the description, serve to explain principles of the disclosed embodiments as set forth in the accompanying claims.

### BRIEF DESCRIPTION OF THE DRAWINGS

An exemplary electronic transaction device, and an exemplary method of identifying potentially fraudulent electronic transactions will now be described, with reference to the accompanying drawings, in which:

FIG. 1 is a diagram of an exemplary electronic transaction network, depicting an exemplary electronic transaction device and an exemplary financial institution server, in accordance with the disclosed embodiments;

FIG. 2 is a diagram an exemplary electronic transaction device, consistent with the disclosed embodiments; and

FIG. 3 is a flow chart of an exemplary method of identifying potentially fraudulent electronic transactions, consistent with disclosed embodiments.

### DETAILED DESCRIPTION

### Electronic Transaction Network

Reference will now be made in detail to disclosed embodiments, examples of which are illustrated in the accompanying drawings. The same reference numbers in the drawings and this disclosure are intended to refer to the same or like elements, components, and/or parts.

In this application, the use of the singular includes the plural unless specifically stated otherwise. In this application, the use of “or” means “and/or” unless stated otherwise. Furthermore, the use of the term “including,” as well as other forms such as “includes” and “included,” is not limiting. In addition, terms such as “element” or “component” encompass both elements and components including one unit, and elements and components that include more than one subunit, unless specifically stated otherwise. Additionally, any section headings used herein are for organizational purposes only, and are not to be construed as limiting the subject matter described.

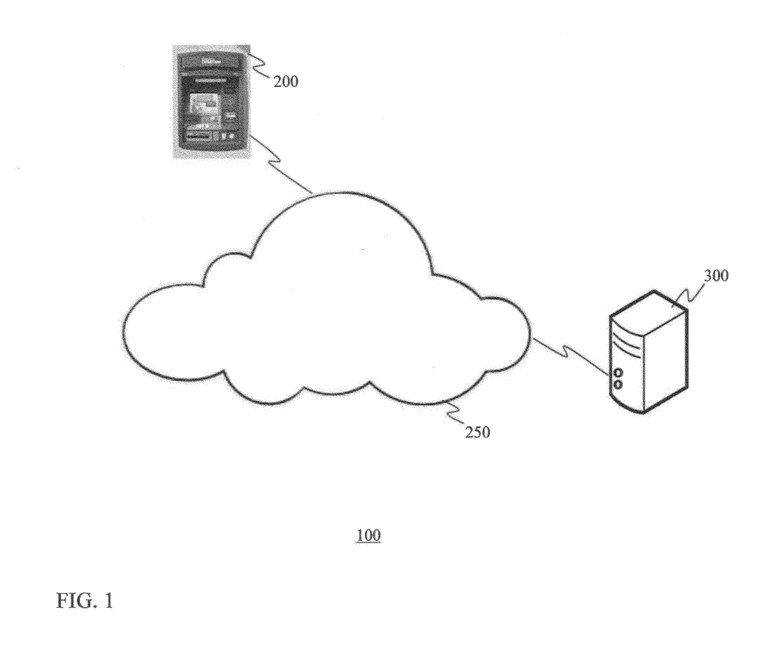

FIG. 1 is a diagram of exemplary an electronic transaction network, denoted generally as 100. As shown in FIG. 1, the electronic transaction network 100 includes electronic transaction device 200, a secure communications network 250, and a transaction processing server 300. Although the exemplary electronic transaction network 100 of FIG. 1 includes only one electronic transaction device 200, the electronic transaction network 100 may include a plurality of the electronic transaction devices 200.

The electronic transaction device 200 may be used to initiate and complete an electronic transaction with the transaction processing server 300, via the secure communications network 250. As used herein, an electronic transaction may include, but is not limited to, a deposit of monetary funds, a withdrawal of monetary funds, a transfer of monetary funds, a bill payment transaction, and an account balance query. Further, the electronic transaction is not limited to transactions involving monetary funds, but may also include transactions involving other items, such as loyalty points.

In some embodiments, the secure communications network 250 includes a payment network, and the electronic transaction device 200 may be implemented as a secure tamper-resistant communications terminal that is configured to communicate with the transaction processing server 300 via the secure communications network 250. As an example, the electronic transaction device 200 may be implemented as an automated teller machine (ATM) or an automated banking machine (ABM). In other aspects, however, the secure communications network 250 may include a wide area communications network, and the electronic transaction device 200 may be implemented as a mobile computing device that is configured to communicate with the transaction processing server 300 via the wide area communications network 250. By way of example, the electronic transaction device 200 may be implemented as a point-of-sale terminal, a wireless personal communications device or a personal computer.

### Electronic Transaction Device

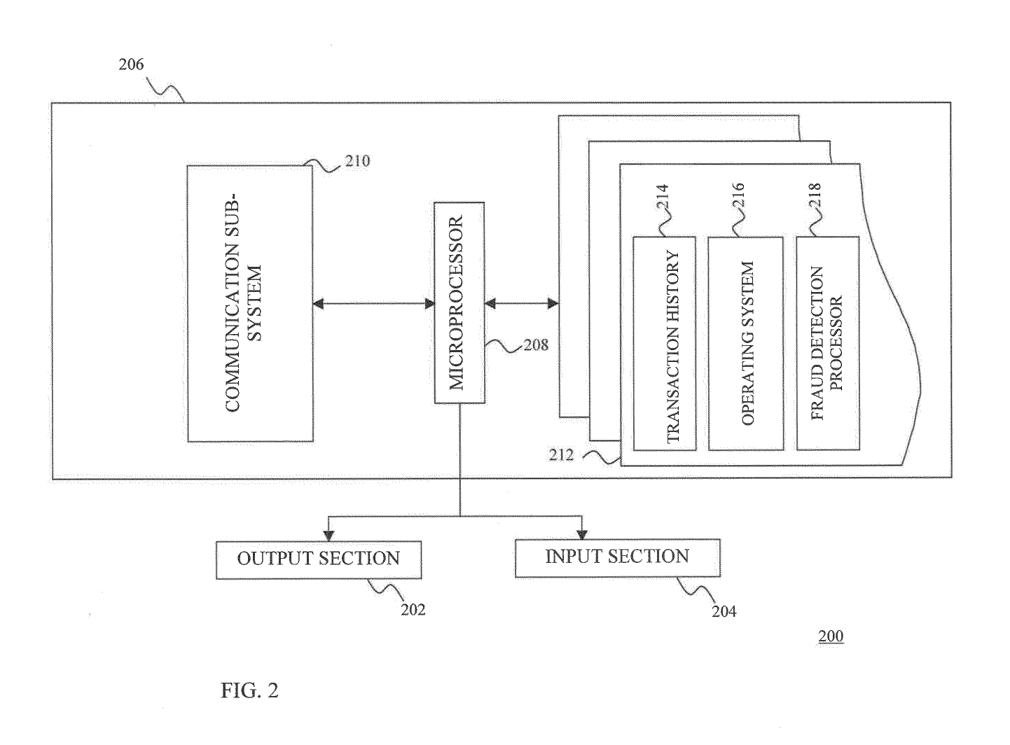

An exemplary electronic transaction device 200 is depicted in FIG. 2. As shown in FIG. 2, the transaction device 200 includes an output section 202, a user input section 204, and a data processing system 206. The output section 202 may include a display device and may also include a speaker or alarm. The user input section 204 may include an authentication credential input device for reading a non-biometric authentication credential, and a biometric credential input device for reading a biometric credential. In some aspects, the authentication credential may include account particulars (e.g. payment card number and/or a primary account number for a deposit account, a credit card account, a line of credit account, and/or a loyalty points account), and the authentication credential input device may include a non-contact card reader and/or a contactless card reader for reading the account particulars from a payment card (e.g. debit card, a credit card, and/or a loyalty card).

In certain aspects, the biometric credential may include a voice print, a fingerprint, and/or a facial image, and the biometric credential input device may include a microphone, fingerprint scanner and/or a camera. The user input section 204 may also include a keyboard/keypad and/or touchscreen for receiving user credentials (e.g. personal identification numbers) and user commands that may be required by the transaction device 200.

The data processing system 206 may include a microprocessor 208, a communication sub-system 210 and a computer-readable medium 212. In some embodiments, the communication sub-system 210 may allow the transaction device 200 to communicate with the transaction processing server 300 via the secure communications network 250.

The computer-readable medium 212 may be include a tangible, non-transitory computer-readable storage medium, such as electronic computer memory (e.g. flash memory) or optical or magnetic memory (e.g. compact disc, hard disk), and may maintain a transaction history 214. In certain aspects, the transaction history 214 may include one or more entries, each associated with a respective electronic transaction that was initiated at the transaction device 200. Each entry in the transaction history 214 may include an authentication credential and an associated biometric credential. As discussed above, the authentication credential received from the user input section 204 may include account particulars (e.g. a payment card number and/or a primary account number), and the biometric credential received from the user input section 204 may include a voice print and/or a facial image. In some aspects, each entry in the transaction history 214 may include account particulars and an associated voice print and/or a facial image, as examples.

The memory 212 may also maintain non-transient computer processing instructions stored thereon which, when accessed from the memory 212 and executed by the microprocessor(s) 208, implement an operating system 216 and a fraud detection processor 218. In some aspects, the operating system 216 controls the overall operation of the transaction device 200, and may be configured to provide output to the output section 202, to receive user input from the user input section 204, and/or to send and receive communication signals over the secure communications network 250.

The operation of the fraud detection processor 218 will be discussed in greater detail below. In some aspects, the transaction device 200 may be configured to implement the fraud detection processor 218 to receive from the user input section 204 a request to initiate an electronic transaction at the transaction device 200. The transaction request may include an authentication credential, and may further include a biometric credential sample read from the biometric credential reader 204. The transaction device 200 may also be configured to implement the fraud detection processor 218 to insert into the transaction history 214 a new entry including the biometric credential sample in association with the authentication credential and initiate completion of the electronic transaction by transmitting particulars of the transaction request over the secure communications network 250 (e.g., implemented as a payment network), upon/after locating in the transaction history 214 no prior entry corresponding to the biometric credential sample.

In further aspects, the transaction device may be configured to implement the fraud detection processor 218 to insert into the transaction history 214 a new entry that includes the biometric credential sample in association with the authentication credential, and initiate completion of the electronic transaction by transmitting particulars of the transaction request over the secure communications network 250, upon/after locating in the transaction history 214 a prior entry including the biometric credential sample in association with the authentication credential. Further, the fraud detection processor 218, when implemented by the transaction device 200, may be configured to otherwise insert into the transaction history 214 a new entry that includes the biometric credential sample in association with the authentication credential, and generate an alarm signal identifying the electronic transaction as potentially fraudulent.

In certain embodiments, the transaction device 200 may be configured to execute computer processing instructions to implement the fraud detection processor 218. In other embodiments, however, all or a portion of the functionality of the fraud detection processor 218 may be implemented instead in electronics hardware and/or a special-purpose computing device.

### Transaction Processing Server

The transaction processing server 300 may include a computer server associated with a financial institution (e.g., a financial institution server), and may be configured to facilitate completion of electronic transactions involving monetary funds. As discussed, electronic transactions that are implemented by the electronic transaction network 100 are not limited to transactions involving monetary funds, but may also include transactions involving non-monetary items, such as loyalty points. In some asepcts, the transaction processing server 300 may be configured to facilitate completion of electronic transactions involving, for example, loyalty points.

The transaction processing server 300 may include a network interface (not shown) and a data processing system (not shown). The network interface may, for example, allow the transaction processing server 300 to communicate with the electronic transaction device 200 via the secure communications network 250. The data processing system may include one or more microprocessors, and a tangible, non-transitory computer-readable medium. The computer-readable medium may, for example, maintain non-transient computer processing instructions stored thereon which, when executed by the microprocessor(s), implement an operating system that controls the overall operation of the transaction processing server 300.

The computer-readable medium may also maintain an accounts database (not shown) that includes a plurality of clusters, each associated with a respective account maintained by the transaction processing server 300. Each cluster may include a plurality of database records, each identifying a credit/deposit entry corresponding to the associated account.

As discussed herein, the electronic transaction device 200 may be implemented as a mobile computing device. Accordingly, the computer-readable medium of the transaction processing server 300 may also maintain a transaction history similar to the transaction history 214 of the electronic transaction device 200. In some aspects, the transaction history of the transaction processing server 300 may include one or more entries, each associated with a respective electronic transaction that was initiated at the transaction device 200. Further, each entry may also include an authentication credential and an associated biometric credential.

### Exemplary Method of Identifying Potentially Fraudulent Electronic Transactions

In some embodiments, the electronic transaction device 200 and/or the transaction processing server 300 may operate within the electronic transaction network 100 to implement a method of identifying potentially fraudulent electronic transactions. By way of example, a user of the electronic transaction device 200 may initiate an electronic transaction at the electronic transaction device 200, e.g., using the user input section 204 to generate a request for an electronic transaction with the electronic transaction device 200. As discussed above, the transaction request may include an authentication credential and may further include a biometric credential sample read from the biometric credential reader 204. In some aspects, the electronic transaction device 200 may receive an authentication credential and a biometric credential sample, both of which are associated with the electronic transaction.

In some embodiments, upon/after locating in the transaction history 214 no entry corresponding to the biometric credential sample or an entry including the biometric credential sample in association with the authentication credential, the electronic transaction device 200 may insert into the transaction history 214 a new entry including the biometric credential sample in association with the authentication credential, and may initiate completion of the electronic transaction by transmitting particulars of the transaction request over the payment network 250. Otherwise, the electronic transaction device 200 may insert into the transaction history 214 a new entry including the biometric credential sample in association with the authentication credential, and may generate an alarm signal identifying the electronic transaction as potentially fraudulent.

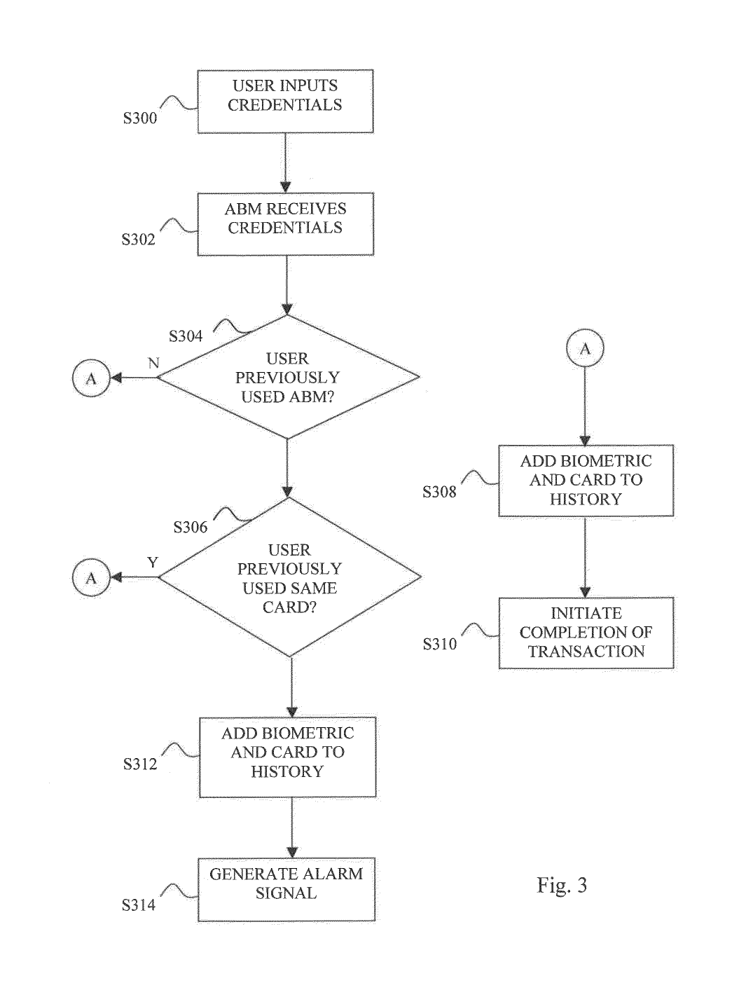

FIG. 3 illustrates an exemplary fraudulent transaction identification method, consistent with the disclosed embodiments. In some embodiments, the transaction processing server 300 may be implemented as a financial institution server. The electronic transaction device 200 may be implemented as an automated banking machine (ABM), and may maintains the transaction history 214 on the electronic transaction device 200. Further, in certain aspects, the transaction history 214 may include only a single entry and, therefore, the electronic transaction device 200 may only maintain a history of the last electronic transaction that was initiated at the electronic transaction device 200. However, as discussed above, the disclosed embodiments are not limited to this particular configuration.

To initiate the electronic transaction, the user of the electronic transaction device 200 may generate a request for an electronic transaction at the electronic transaction device 200 by inputting an authentication credential and a biometric credential sample into the user input section 204 (e.g., at step S300). As discussed above, the authentication credential may include account particulars which the user may enter into the electronic transaction device 200 using the card reader of the user input section 204. The biometric credential sample may include a voice print and/or a facial image, which the user may enter into the electronic transaction device 200 using the microphone or camera of the user input section 204.

The fraud detection processor 218 may receive the authentication credential and a biometric credential sample (e.g., at step S302). The electronic transaction device 200 may, for example, determine the extent to which the user previously used the electronic transaction device 200. To do so, at step S304, the fraud detection processor 218 may query the transaction history 214 with the biometric credential sample. If the fraud detection processor 218 does not locate any entry in the transaction history 214 that includes the biometric credential sample (e.g., the user has not previously used the electronic transaction device 200), at step S308 the fraud detection processor 218 may insert into the transaction history 214 an entry that including the biometric credential sample and the authentication credential. in certain aspects, the fraud detection processor 218 may initiate completion of the electronic transaction by authenticating the transaction request (e.g., at step S310).

If the fraud detection processor 218 locates an entry in the transaction history 214 that includes the biometric credential sample (e.g., step S304), at step S306 the fraud detection processor 218 may query the transaction history 214 with the biometric credential sample and the authentication credential. If the fraud detection processor 218 locates an entry in the transaction history 214 that includes the biometric credential sample in association with the authentication credential (e.g., the user previously used the same payment card at the electronic transaction device 200), at step S308 the fraud detection processor 218 may insert into the transaction history 214 a new entry that includes the biometric credential sample and the authentication credential. The fraud detection processor 218 may initiate completion of the electronic transaction by authenticating the transaction request (e.g., at step S310).

As discussed above, and in some embodiments, the transaction history 214 may only maintain a single entry. Therefore, at step S308, the fraud detection processor 218, in effect, may purge the transaction history 214 upon/prior to inserting the new entry into the transaction history 214. However, in other embodiments, each new entry inserted into the transaction history 214 includes a timestamp. Further, the transaction history 214 may also allow multiple entries. For instance, at step S308, the fraud detection processor 218 may calculate the elapsed time between the current date/time and the timestamp of all the prior entries in the transaction history 214 (or the time stamp of the single prior entry in the transaction history 214). If the calculated elapsed time for any such prior entry exceeds a predetermined time limit, the fraud detection processor 218 may delete the prior entry from the transaction history 214. In some aspects, the fraud detection processor 218 may delete an entry from the transaction history 214 a predetermined time after inserting the entry into the transaction history 214. In this manner, the transaction history 214 may only maintain a transient history of the electronic transactions that were initiated at the electronic transaction device 200.

If the fraud detection processor 218 locates an entry in the transaction history 214 that includes the biometric credential sample (e.g., step S304), but does not locate an entry in the transaction history 214 that includes the biometric credential sample in association with the authentication credential (e.g., step S306) (e.g., the user has previously used a different payment card at the electronic transaction device 200), at step S312 the fraud detection processor 218 may insert into the transaction history 214 a new entry that includes the biometric credential sample and the authentication credential. The fraud detection processor 218 may, in some aspects, generate an alarm signal identifying the electronic transaction as potentially fraudulent (e.g., at step S314). The fraud detection processor 218 may transmit the alarm signal to a monitoring agency, and may optionally trigger an audio and/or visual alarm at the electronic transaction device 200.

At step S310, the fraud detection processor 218 may initiate completion of the electronic transaction by requesting that the user enter particulars of the electronic transaction (e.g. a transaction type (withdrawal, deposit, transfer, etc.), an account selection, and/or monetary/points amount) and a user credential (e.g. a personal identification number) into the electronic transaction device 200 via the keyboard/keypad/touchscreen of the user input section 214, and by authenticating the transaction request. Alternately, the transaction particulars and the user credential may have been included with the transaction request (e.g., at step S300).

If the payment card is implemented as a magnetic stripe card, the fraud detection processor 218 may authenticate the transaction request (e.g., at step S310) by transmitting the user credential and the authentication credential to the transaction processing server 300 for validation. If the payment card is implemented as a smartcard, the fraud detection processor 218 may authenticate the transaction request at step S310 by transmitting the user credential and the monetary/points amount to the payment card, receiving a cryptogram from the payment card in response, and transmitting the cryptogram and the authentication credential to the transaction processing server 300 for validation. The transaction processing server 300 may then proceed with the electronic transaction in accordance with an outcome of the validation step.

In embodiments described above, the fraud detection processor 218 may query the transaction history 214 with the biometric credential sample and the authentication credential (e.g., step S306). In other embodiments, at step S306, the fraud detection processor 218 may instead query the results that were obtained from the query at step S304, such as where the transaction history 214 includes more than one entry. Further, although the fraud detection processor 218 may query the transaction history 214 with the biometric credential sample (e.g., at step S304) prior to performing the query with the biometric credential sample and the authentication credential (e.g., at step S306), it should be understood that this sequence of steps can be reversed. Moreover although the fraud detection processor 218 may update the transaction history 214 with the new entry after querying the transaction history 214 (e.g., at steps S304, S306), the fraud detection processor 218 may instead update the transaction history 214 with the new entry prior to querying the transaction history 214 at steps S304, S306. For example, depending on the number of entries allowed in the transaction history 214, the fraud detection processor 218 may update the transaction history 214 with the new entry upon receipt of the authentication credential and the biometric credential sample, at step S302.

Certain aspects of the disclosures described herein include process steps and instructions described herein in the form of an algorithm. It should be noted that the process steps and instructions of the disclosed embodiments can be embodied in software, firmware or hardware, and when embodied in software, can be downloaded to reside on and be operated from different platforms used by real time network operating systems.

Also described herein are exemplary apparatuses, systems, and devices for performing the operations herein. These apparatuses, systems, and devices may be specially constructed for the required purposes, or may include a general-purpose computer selectively activated or reconfigured by a computer program stored in the computer. Such a computer program may be stored in a tangible, non-transitory computer-readable storage medium, such as, but is not limited to, any type of disk including floppy disks, optical disks, CD-ROMs, magnetic-optical disks, read-only memories (ROMs), random access memories (RAMS), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description above. In addition, the disclosed embodiments are not described with reference to any particular programming language. It is appreciated that a variety of programming languages may be used to implement the disclosed embodiments, and any references to specific languages are provided for disclosure of enablement and best mode.

Various embodiments have been described herein with reference to the accompanying drawings. It will, however, be evident that various modifications and changes may be made thereto, and additional embodiments may be implemented, without departing from the spirit or scope of the disclosed embodiments, as set forth in the claims that follow.

Further, other embodiments will be apparent to those skilled in the art from consideration of the specification and practice of one or more embodiments of the present disclosure. It is intended, therefore, that this disclosure and the examples herein be considered as exemplary only, with a true scope and spirit of the disclosed embodiments being indicated by the following listing of exemplary claims.

What is claimed is:

1. A method of identifying potentially fraudulent electronic transactions at an electronic transaction device, the electronic transaction device including a biometric credential reader and maintaining at the electronic transaction device a transaction history of electronic transactions initiated at the electronic transaction device, the method comprising:
receiving, by the electronic transaction device, a transaction request for an electronic transaction with the electronic transaction device, the electronic transaction request comprising an authentication credential and further comprising a biometric credential sample read from the biometric credential reader; and
upon the electronic transaction device locating in the transaction history (i) no entry corresponding to the biometric credential sample or (ii) an entry comprising the biometric credential sample in association with the authentication credential, inserting, by the electronic transaction device, and into the transaction history, a new entry comprising the biometric credential sample in association with the authentication credential and initiating completion of the electronic transaction by transmitting particulars of the transaction request over a payment network,
otherwise, inserting, by the electronic transaction device, and into the transaction history, the new entry comprising the biometric credential sample in association with the authentication credential and generating, by the electronic transaction device, an alarm signal identifying the electronic transaction as potentially fraudulent.

2. The method according to claim 1, wherein the inserting comprises the electronic transaction device deleting from the transaction history the new entry comprising the biometric credential sample in association with the authentication credential a predetermined time after inserting the new entry into the transaction history.

3. The method according to claim 1, wherein the inserting comprises the electronic transaction device purging the transaction history prior to inserting into the transaction history the new entry comprising the biometric credential sample in association with the authentication credential.

4. The method according to claim 1, wherein the biometric credential sample comprises a facial image.

5. The method according to claim 1, wherein the authentication credential comprises an account credential.

6. An electronic transaction device comprising:
a biometric credential reader;
a storage device storing a transaction history of electronic transactions initiated at the electronic transaction device, the transaction history being local to the electronic transaction device; and
at least one processor coupled to the storage device and the biometric credential reader, the storage device further storing software instructions for controlling the at least one processor when executed by the at least one processor, and the at least one processor being operative with the software instructions and configured to:
receive a transaction request for an electronic transaction with the electronic transaction device, the electronic transaction request comprising an authentication credential and further comprising a biometric credential sample read from the biometric credential reader; and
upon locating in the transaction history (i) no entry corresponding to the biometric credential sample or (ii) an entry comprising the biometric credential sample in association with the authentication credential, insert into the transaction history a new entry comprising the biometric credential sample in association with the authentication credential and initiate completion of the electronic transaction by transmitting particulars of the transaction request over a payment network,
otherwise insert into the transaction history the new entry comprising the biometric credential sample in association with the authentication credential and generate an alarm signal identifying the electronic transaction as potentially fraudulent.

7. The electronic transaction device according to claim 6, wherein the at least one processor is further configured to insert the new entry comprising the biometric credential sample in association with the authentication credential by deleting the new entry from the transaction history a predetermined time after inserting the new entry into the transaction history.

8. The electronic transaction device according to claim 6, wherein the at least one processor is further configured to insert the new entry comprising the biometric credential sample in association with the authentication credential by purging the transaction history prior to inserting into the transaction history the new entry comprising the biometric credential sample in association with the authentication credential.

9. electronic transaction device according to claim 6, wherein the biometric credential sample comprises a facial image.

10. The electronic transaction device according to claim 6, wherein the authentication credential comprises an account credential.

11. A tangible, non-transitory computer-readable medium storing instructions which, when executed by at least one processor, cause the at least one processor to perform a method of identifying potentially fraudulent electronic transactions at an electronic transaction device, the electronic transaction device including a biometric credential reader and maintaining at the electronic transaction device a transaction history of electronic transactions initiated at the electronic transaction device, the method comprising:
receiving a transaction request for an electronic transaction with the electronic transaction device, the electronic transaction request comprising an authentication credential and further comprising a biometric credential sample read from the biometric credential reader; and
upon the electronic transaction device locating in the transaction history (i) no entry corresponding to the biometric credential sample or (ii) an entry comprising the biometric credential sample in association with the authentication credential, inserting into the transaction history a new entry comprising the biometric credential sample in association with the authentication credential and initiating completion of the electronic transaction by transmitting particulars of the transaction request over a payment network,
otherwise, inserting into the transaction history, the new entry comprising the biometric credential sample in association with the authentication credential and generating an alarm signal identifying the electronic transaction as potentially fraudulent.
